(19) United States
(12) Patent Application Publication
(10) Pub. No.: US 2026/0290837 A1
(43) Pub. Date: Sep. 24, 2026

(54) SECONDARY BATTERY, SECONDARY BATTERY ELECTRODE, SECONDARY BATTERY MANUFACTURING METHOD, AND SECONDARY BATTERY ELECTRODE MANUFACTURING METHOD

(71) Applicants: NATIONAL UNIVERSITY CORPORATION TOKAI NATIONAL HIGHER EDUCATION AND RESEARCH SYSTEM, Nagoya-shi, Aichi (JP); NU-Rei Co., Ltd, Nagoya-shi, Aichi (JP)

(72) Inventors: Masaru HORI, Nissin-shi (JP); Osamu ODA, Shinagawa-ku (JP); Van Nong NGO, Nagoya-shi (JP); Swapnil Chetan GHODKE, Tama-shi (JP); Dennis Christy PETER RAJ, Vantaa (FI)

(73) Assignees: NATIONAL UNIVERSITY CORPORATION TOKAI NATIONAL HIGHER EDUCATION AND RESEARCH SYSTEM, Nagoya-shi, Aichi (JP); NU-Rei Co., Ltd, Nagoya-shi, Aichi (JP)

(21) Appl. No.: 18/998,017

(22) PCT Filed: Jul. 24, 2024
(86) PCT No.: PCT/JP2023/027077

§ 371 Date: Dec. 12, 2025

(30) Foreign Application Priority Data
Jul. 26, 2002 (JP) 2022-118686

(51) Int. Cl. H01M 4/66; H01M 4/04; H01M 10/0525

(52) U.S. Cl. CPC H01M 4/661; H01M 4/0452; H01M 10/0525

(57) ABSTRACT

There is provided a secondary battery, comprising a container filled with an electrolytic solution; a separator having electrical insulation property and ion conductivity and configured to divide an internal space of the container into a first electrode chamber and a second electrode chamber; a first electrode configured by a metal substrate and placed in the first electrode chamber; and a second electrode placed in the second electrode chamber and including a metal atom which is ionized and moved to the first electrode. The metal substrate has a fine concavo-convex structure, which is formed on an outer surface, including a plurality of convexes that are made of metal particles having a maximum width of not less than 0.5 μm and not greater than 30.0 μm. The secondary battery is configured so that the metal atom deposits on surface of the convexes in a process of charging.

### TECHNICAL FIELD

The present disclosure relates to a secondary battery, an electrode for a secondary battery, a manufacturing method of a secondary battery, and a manufacturing method of an electrode for a secondary battery.

### BACKGROUND

A secondary battery is known as one aspect of a chargeable and dischargeable accumulation device. In general, on a surface of a current collector in an electrode of the secondary battery, an active material layer formed of a material involved in a battery reaction of the secondary battery is formed. For example, in lithium ion secondary batteries disclosed in first patent literature, Japanese Patent No. 2668678B, and second patent literature, Japanese Patent No. 2010-9980A, a lithium (Li)-containing active material layer is provided in a positive electrode, and an active material layer formed of carbon (C) is provided in a negative electrode.

In the technical field of the secondary battery, there has been a common technical wisdom that the active material layer of the electrode significantly affects the battery performance. A variety of active material layers have accordingly been studied extensively, with a view to improving the battery performance of the secondary battery. As one example of such research findings, it has been found that, in a lithium ion secondary battery, an active material layer of carbon nanowalls as described in above second patent literature formed on a negative electrode more significantly improves the battery performance, compared with an active material layer of graphite as described in above first patent literature.

### SUMMARY

### Technical Problem

Even application of the active material layer of the carbon nanowalls to the lithium ion secondary battery as described above, however, still fails to sufficiently achieve the target of the high battery performance required for the secondary battery. The same is true in the case of applying a material other than the carbon nanowalls to the active material in a secondary battery other than the lithium ion secondary battery.

There may be a difficulty in mass producing the electrode for the secondary battery, depending on the type of the active material layer. For example, in a manufacturing process of the lithium ion secondary battery, when an electrode having an active material layer of carbon nanowalls is rolled up for the purpose of transfer, storage or the like, the carbon nanowalls may be destroyed or dropped off by a compression stress or a shear stress.

The problems described above are not limited to the lithium ion secondary battery but is commonly found in a variety of secondary batteries. An object of the present disclosure is thus to provide an electrode for a secondary battery, which achieves the high battery performance, which has a simple configuration, and which is readily manufactured, as well as a secondary battery using such an electrode.

### Solution to Problem

The inventors of the present disclosure have obtained a finding that defies the common technical wisdom with regard to the active material layer described above in the course of intensive studies of the electrode for the accumulation device and have succeeded in developing an electrode for a secondary battery that has a simpler configuration than the conventional one, that is readily manufactured and that significantly improves the battery performance. The present disclosure may be implemented by, for example, an aspect described below.

According to one aspect of the present disclosure, there is provided a secondary battery. The secondary battery of this aspect comprises a container filled with an electrolytic solution; a separator having electrical insulation property and ion conductivity and configured to divide an internal space of the container into a first electrode chamber and a second electrode chamber; a first electrode configured by a metal substrate and placed in the first electrode chamber; and a second electrode placed in the second electrode chamber and including a metal atom which is ionized and moved to the first electrode. The metal substrate has a fine concavo-convex structure, which is formed on an outer surface, including a plurality of convexes that are made of metal particles having a maximum width of not less than 0.5 μm and not greater than 30.0 μm. The secondary battery is configured so that the metal atom deposits on surface of the convexes in a process of charging.

The inventors of the present disclosure have found that the configuration of the first electrode that is not provided with an active material layer on a surface thereof but that is configured by the metal substrate having the concavo-convex structure, which is formed on the outer surface thereof and which includes the convexes of the above dimensions, more significantly improves the battery performance of the secondary battery, compared with a configuration provided with an active material layer. The secondary battery of this aspect enhances the charging capacity and improves the battery performance by the novel configuration without providing an active material layer on the first electrode. The secondary battery of this aspect does not require to provide an active material layer on the first electrode. This configuration accordingly simplifies a manufacturing process of the secondary battery.

The present disclosure may be implemented by a variety of aspects other than the secondary battery. The present disclosure may be implemented by, for example, aspects of an electrode for a secondary battery, a manufacturing method of a secondary battery, a manufacturing method of an electrode for a secondary battery, and manufacturing apparatuses configured to perform these manufacturing methods. The present disclosure may also be implemented by, for example, aspects of an apparatus or a system driven by electric power of a secondary battery, and a power generation apparatus or a power generation system provided with a secondary battery.

### BRIEF DESCRIPTION OF DRAWINGS

FIG. 1 is a schematic diagram illustrating the configuration of a secondary battery;

FIG. 2 is a schematic sectional view schematically illustrating a first configuration example of a convex of a metal substrate;

FIG. 3 is a schematic sectional view schematically illustrating a second configuration example of the convex of the metal substrate;

FIG. 4 is a process flowchart showing a process of manufacturing the secondary battery;

FIG. 5 is a schematic diagram illustrating the configuration of a surface treatment device;

FIG. 6 is an explanatory diagram including photographed images of examples;

FIG. 7 is an explanatory diagram including photographed images of comparative examples;

FIG. 8 is an explanatory diagram showing the results of an evaluation test of the battery performance of a first example;

FIG. 9 is an explanatory diagram showing the results of the evaluation test of the battery performance of a second example;

FIG. 10 is an explanatory diagram showing the results of the evaluation test of the battery performance of a first comparative example;

FIG. 11 is an explanatory diagram showing the results of the evaluation test of the battery performance of a second comparative example;

FIG. 12 is an explanatory diagram showing the results of the evaluation test of the battery performance of a third comparative example; and

FIG. 13 is an explanatory diagram showing the results of the evaluation test of the battery performance of the example and the comparative examples.

### DESCRIPTION OF EMBODIMENTS

The following describes embodiments of the secondary battery, the electrode for the secondary battery, the manufacturing method of the secondary battery and the manufacturing method of the electrode for the secondary battery according to the present disclosure with referring to drawings.

### 1. Embodiment

### 1-1. Configuration of Secondary Battery

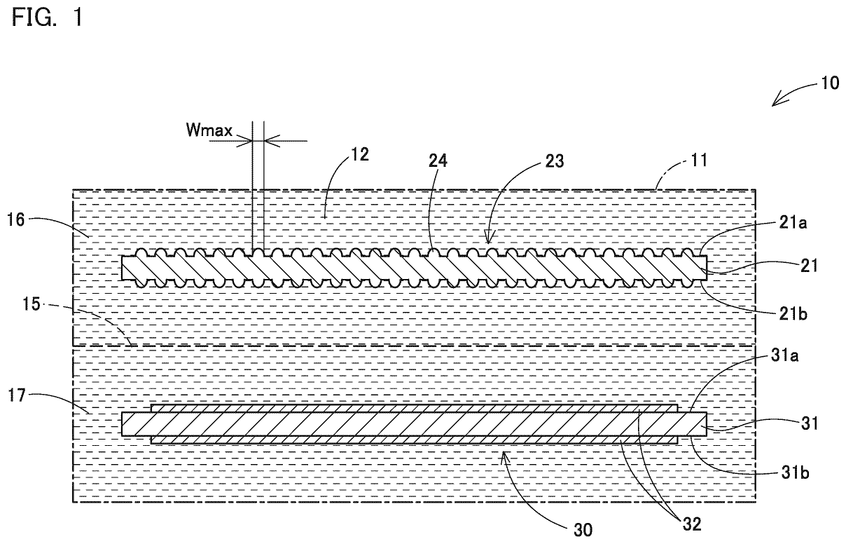

FIG. 1 is a schematic diagram illustrating the configuration of a secondary battery 10 according to one embodiment. The secondary battery 10 of the embodiment is a lithium ion secondary battery with lithium (Li) ion involved in charge and discharge. The secondary battery 10 includes a container 11, an electrolytic solution 12, a separator 15, a first electrode 20 and a second electrode 30. For the purpose of convenience, the container 11 is shown by dash-dotted line and the separator 15 is shown by broken line in FIG. 1.

The container 11 has an internal space filled with the electrolytic solution. The container 11 is formed of a material that is unlikely to react with the electrolytic solution 12 and is formed in a liquid-tight manner. The electrolytic solution 12 has a property of enabling a metal ion involved in charge and discharge to be transmitted between the first electrode 20 and the second electrode 30. According to the embodiment, the electrolytic solution 12 is a solution prepared by dissolving a lithium salt in an organic solvent and configured to transmit the lithium ion. One usable example as the lithium salt of the electrolytic solution 12 is lithium hexafluorophosphate (LiPF₆). Usable examples as the organic solvent include dimethyl carbonate (DMC), diethyl carbonate (DEC), and ethyl methyl carbonate (EMC).

The separator 15 is configured to divide the internal space of the container 11 into a first electrode chamber 16 which the first electrode 20 is placed in and a second electrode chamber 17 which the second electrode 30 is placed in. The separator 15 consists of a thin film member, for example, such as a resin film having a porous structure or a non-woven fabric, and has electrical insulation property and ion conductivity. The separator 15 serves to electrically insulate the first electrode 20 and the second electrode 30 from each other and to allow for permeation of the metal ion that is transmitted via the electrolytic solution 12.

The first electrode 20 corresponds to the electrode for the secondary battery according to the embodiment. In the description below, the first electrode 20 may be simply referred to as the “electrode 20”. In the secondary battery 10 of the embodiment, the electrode 20 constitutes a negative electrode. The electrode 20 consists of a metal substrate 21.

According to the embodiment, the metal substrate 21 is formed of a copper (Cu) metal foil. Cu is easy to form a concavo-convex structure described later on an outer surface thereof and is also easy to improve the battery performance of the secondary battery 10. Cu is readily available and is also readily processable. The metal substrate 21 may be formed of a Cu alloy. The metal substrate 21 is not necessarily formed of a metal foil but may be formed of, for example, a metal thin plate. The metal substrate 21 is not necessarily formed in a flat plate-like shape but may be bent in a variety of shapes, such as a tubular shape or a wave-like shape.

The metal substrate 21 serves as a current collector of the electrode 20. In a conventional secondary battery, an active material layer formed of a material involved in charge and discharge is generally provided on the surface of the current collector. According to the embodiment, however, such an active material layer is not formed on the surface of the metal substrate 21. Instead, a fine concavo-convex structure 23 is formed on the outer surface of the metal substrate 21 according to the embodiment. The concavo-convex structure 23 is provided on both a first surface 21a and a second surface 21b of the metal substrate 21.

The concavo-convex structure 23 includes a plurality of convexes 24 having a maximum width Wmax in a range of not less than 0.5 μm and not greater than 30.0 μm. The convexes 24 are portions protruded in a thickness direction of the metal substrate 21. The convex 24 is made of one or a plurality of metal particles as described later. The “metal particle” means an agglomeration of metal having a particle-like shape. This metal particle is formed of the same type of metal as the metal constituting the metal substrate 21. In the case where the metal substrate 21 is formed of an alloy, the metal particle is formed of the same type of metal as the metal that is a primary material of the alloy.

The maximum width Wmax of the convex 24 denotes a maximum value out of the widths of every direction of the convex 24 that are measured in photographed images taken from a direction facing the surface of the metal substrate 21 by, for example, a scanning electron microscope or the like. The direction “facing the surface of the metal substrate 21” corresponds to a thickness direction of the metal substrate 21. “Every direction” herein corresponds to all directions perpendicular to the thickness direction of the metal substrate 21. These definitions are equally applied in the description below.

A lower limit of the maximum width Wmax of the convex 24 is preferably not less than 0.6 μm and is more preferably not less than 0.8 μm. An upper limit of the maximum width Wmax of the convex 24 is preferably not greater than 28.0 μm and is more preferably not greater than 25.0 μm. The concavo-convex structure 23 may include convexes having smaller widths than the lower limit in the numerical range of the maximum width Wmax described above, in addition to the convexes 24 having the widths included in the numerical range of the maximum width Wmax.

As described above, no active material layer is formed on the metal substrate 21, and each of the convexes 24 of the concavo-convex structure 23 is directly soaked in the electrolytic solution 12 in the secondary battery 10 prior to charge. The term “prior to charge” herein means the state that the battery has never been charged after produced. As described later, in the process of charging the secondary battery 10, the metal atom, Li in this embodiment, ionized and moved from the second electrode 30 deposits on the surface of the convexes 24 of the concavo-convex structure 23.

The details of the structure of the convexes 24 and a method of forming the concavo-convex structure 23 of the metal substrate 21 will be described later.

The second electrode 30 serves as a positive electrode of the secondary battery 10. The second electrode 30 includes a positive electrode current collector 31 and a positive electrode active material layer 32. The positive electrode current collector 31 is formed of, for example, a metal foil of aluminum (Al), titanium (Ti) or the like. The positive electrode current collector 31 may be formed of another metal or may have a form other than the metal foil. The positive electrode current collector 31 is not necessarily formed in a flat shape but may be bent in a variety of shapes, such as a tubular shape or a wave-like shape.

The positive electrode active material layer 32 is formed on both a first surface 31a and a second surface 31b of the positive electrode current collector 31. The positive electrode active material layer 32 includes a Li atom-containing positive electrode active material, a conductive assistant, and a binding agent. The positive electrode active material layer 32 may further include a thickener. A material in a ternary system, for example, lithium cobaltate (LiCoO₂), lithium manganate (LMO), or lithium nickelate (NCA) may be used as the positive electrode active material. Usable examples as the conductive assistant include acetylene black and carbon black. Usable examples as the binding agent include polyvinylidene fluoride (PVDF) and styrene butadiene rubber (SBR). One usable example as the thickener is carboxymethyl cellulose (CMC).

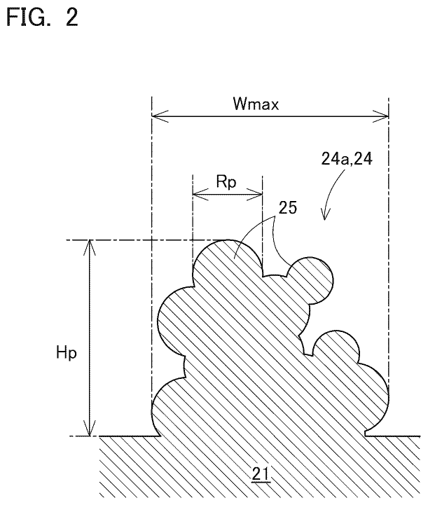

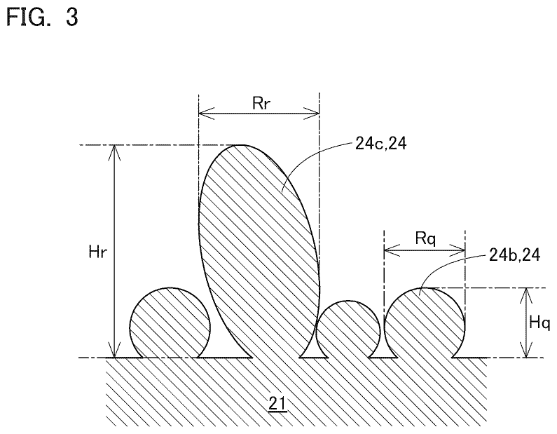

Referring to FIG. 2 and FIG. 3, the following describes examples of the structure of the convexes 24 constituting the concavo-convex structure 23 of the metal substrate 21. Each of FIG. 2 and FIG. 3 is a schematic sectional view schematically illustrating part of a sectional structure of the metal substrate 21 in an arbitrary cutting plane along a thickness direction.

FIG. 2 and FIG. 3 respectively illustrate configuration examples of the convex 24 in different shapes. FIG. 2 illustrates a protrusion 24a as a first configuration example of the convex 24. FIG. 3 illustrates a first granule 24b as a second configuration example of the convex 24 and a second granule 24c as a third configuration example of the convex 24. These configuration examples of the convex 24 are sequentially described below.

Referring to FIG. 2, the protrusion 24a as the first configuration example of the convex 24 is formed by densely gathering a plurality of fine metal particles 25 having a particle diameter Rp of not less than 0.5 μm and not greater than 5.0 μm in a cluster. The protrusion 24a has a tufted structure of a plurality of fine metal particles 25. The protrusion 24a has an irregular structure formed by densely arranging the fine metal particles 25 on the surface thereof and has, as a whole, a structure projected from the periphery.

In the description hereof, the term “particle” is a concept that means a minute agglomeration in a variety of shapes and that is not necessarily limited to an approximate spherical shape but includes a deformed shape having a random irregular structure on the surface thereof. In the description hereof, the “particle diameter” means a maximum value out of diameters of a particle in every direction measured in a plurality of images taken from a direction facing the metal substrate 21 by using, for example, a scanning electron microscope or the like.

In the protrusion 24a, the maximum width Wmax of the convex 24 described above denotes a maximum value out of end-to-end distances of the plurality of metal particles 25 constituting the protrusion 24a in directions perpendicular to the thickness direction of the metal substrate 21. A lower limit of the particle diameter Rp of each of the metal particles 25 constituting the protrusion 24a is preferably not less than 0.6 μm and is more preferably not less than 0.8 μm. An upper limit of the particle diameter Rp of each of the metal particles 25 is preferably not greater than 4.0 μm and is more preferably not greater than 3.0 μm.

The protrusion 24a has a height Hp of not less than 1.0 μm and not greater than 15.0 μm. The height Hp of the protrusion 24a denotes a distance in the thickness direction of the metal substrate 21 between a lowermost end an uppermost end of the protrusion 24a, which is measured in a photographed image taken from a direction perpendicular to the thickness direction of the metal substrate 21 by using, for example, a scanning electron microscope. A lower limit of the height Hp of the protrusion 24a is preferably not less than 2.0 μm and is more preferably not less than 4.0 μm. An upper limit of the height Hp of the protrusion 24a may be not greater than 12.0 μm or may be even not greater than 10.0 μm.

Referring to FIG. 3, the first granule 24b as the second configuration example of the convex 24 and the second granule 24c as the third configuration example of the convex 24 are commonly consist of the metal particles 25 recognized as single bodies but have different dimensions and different shapes. The first granule 24b and the second granule 24c especially have different heights. The height of the granule 24b or the granule 24c denotes a distance in the thickness direction of the metal substrate 21 between a lowermost end an uppermost end of the granule 24b or the granule 24c, which is measured in a photographed image taken from the direction perpendicular to the thickness direction of the metal substrate 21 by using, for example, a scanning electron microscope.

The first granule 24b has a particle diameter Rq of not less than 0.5 μm and not greater than 5.0 μm and has a height Hq that is approximately not greater than the particle diameter Rq. The particle diameter Rq of the first granule 24b corresponds to the maximum width Wmax of the convex 24. A lower limit of the particle diameter Rq of the first granule 24b is preferably not less than 0.6 μm and is more preferably not less than 0.8 μm. An upper limit of the particle diameter Rq of the first granule 24b may be not greater than 4.5 μm and may be even not greater than 4.0 μm.

The second granule 24c has a vertically long shape. The second granule 24c has a particle diameter Rr of not less than 0.5 μm and not greater than 8.0 μm and has a height Hr that is greater than the particle diameter Rr. The particle diameter Rr of the second granule 24c corresponds to the maximum width Wmax of the convex 24. A lower limit of the particle diameter of the second granule 24c is preferably not less than 0.6 μm and is more preferably not less than 0.8 μm. An upper limit of the particle diameter of the second granule 24c may be not greater than 7.0 μm and may be even not greater than 5.0 μm.

The height Hr of the second granule 24c may be, for example, not less than 1.0 μm and not greater than 12.0 μm. A lower limit of the height Hr of the second granule 24c may be not less than 2.0 μm and may be even not less than 3.0 μm. An upper limit of the height Hr of the second granule 24c may be not greater than 10.0 μm and may be even not greater than 8.0 μm.

The concavo-convex structure 23 may have such a configuration that the protrusions 24a are densely placed on the surface of the metal substrate 21. The concavo-convex structure 23 may have such a configuration that the first granules 24b and the second granules 24c are placed between the protrusions 24a. The concavo-convex structure 23 may have such a configuration that the first granules 24b or the second granules 24c are distributed over the entire surface of the metal substrate 21. The concavo-convex structure 23 may have such a configuration that the protrusions 24a and the second granules 24c are placed between the first granules 24b which are placed over the entire surface of the metal substrate 21. The concavo-convex structure 23 may have such a configuration that the protrusions 24a, the first granules 24b and the second granules 24c are mixed. The concavo-convex structure 23 may have such a configuration as to include particulate projections smaller than the first granules 24b and the second granules 24c, in addition to the convexes 24.

The area of a projection range obtained by projecting the convexes 24 including the protrusions 24a, the granules 24b and the granules 24c described above in the thickness direction of the metal substrate 21 is greater than 0.01 μm² and not greater than 10000 μm². The density of a projection range of the convexes 24 obtained by projecting the metal substrate 21 in the thickness direction is not less than 1 piece/mm² and less than 10⁸ pieces/mm². The convexes 24 of such dimensions may be readily formed by performing surface treatment of the base material of the metal substrate 21 by electrolytic deposition.

### 1-2. Battery Reaction in Secondary Battery

The chemical reaction in the process of charging and discharging the secondary battery 10 may be expressed by, for example, reaction formulae given below. When the positive electrode active material is LiCoO₂, a reaction formula at the second electrode 30 serving as the positive electrode is expressed by an expression (1) given below, where x denotes a fraction of reacting atom and is a real number of greater than 0 and less than 1:

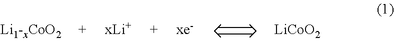

A reaction formula at the electrode 20 serving as the negative electrode is, on the other hand, expressed by an expression (2) given below. As shown by the expression (2), Li deposits on the surface of the convexes 24 of the electrode 20 in the process of charging the secondary battery 10:

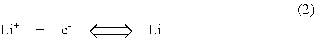

As shown by the above expression (2), the secondary battery 10 of the embodiment is theoretically chargeable as long as Li is allowed to deposit on the electrode 20, and has a high charging capacity.

The inventors of the present disclosure have found that the concavo-convex structure 23 including the convexes 24 of the dimensions described above on the outer surface of the metal substrate 21 constituting the electrode 20 accelerates deposition of Li onto the surface of the metal substrate 21. According to the consideration based on the theory of nucleation, the reason for accelerating the deposition of Li is thought that the convexes 24 of the concavo-convex structure 23 work as starting points to allow for easy deposition of Li.

As described above, in the secondary battery 20 of the embodiment, no active material layer is formed on the electrode 20, but the presence of the convexes 24 in the concavo-convex structure 23 of the metal substrate 21 accelerates deposition of Li on the surface of the metal substrate 21 and thereby improves the battery performance including the charging capacity and the specific capacity. Furthermore, the secondary battery 10 of the embodiment saves the active material layer on the surface of the electrode 20. This simplifies the configuration of the secondary battery 10 and reduces the materials used for manufacturing the secondary battery 10.

Additionally, in the secondary battery 10 of the embodiment, uniform distribution of the convexes 24 of the concavo-convex structure 23 on the surface of the metal substrate 21 allows for uniform deposition of Li on the surface of the metal substrate 21. This suppresses generation of dendrite on the electrode 20 and thereby suppresses the secondary battery 10 from being damaged and deteriorated by the presence of dendrite.

In a conventional manufacturing process of a secondary battery that has an active material layer of, for example, carbon nanowalls, in the case where an electrode with this active material layer formed thereon is rolled up for the purpose of transfer, storage or the like, part of the carbon nanowalls are likely to be damaged or dropped off. The electrode 20 of the embodiment is, on the other hand, free from such a problem of deterioration or drop-off of the active material layer even in the case where the electrode 20 is rolled up for the purpose of transfer or storage in the manufacturing process of the secondary battery 10. This facilitates handling of the electrode 20 of the embodiment and thereby facilitates mass production of the electrode 20.

### 1-3. Manufacturing Method of Secondary Battery

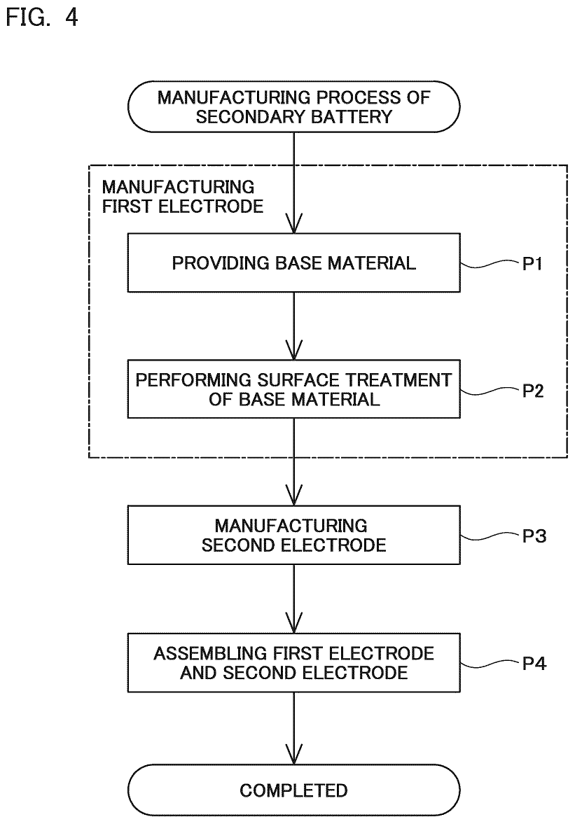

FIG. 4 is a process flowchart showing a manufacturing process of the secondary battery 10. Processes P1 and P2 correspond to a process of manufacturing the electrode 20.

The process P1 is providing a base material BM of the metal substrate 21. The base material BM is, for example, a metal foil or a metal thin plate and has a flat surface. According to the embodiment, the base material BM is a copper foil. The process P2 is performing surface treatment of the base material BM by electrolytic deposition, so as to form the concavo-convex structure 23 described above on respective surfaces of the base material BM.

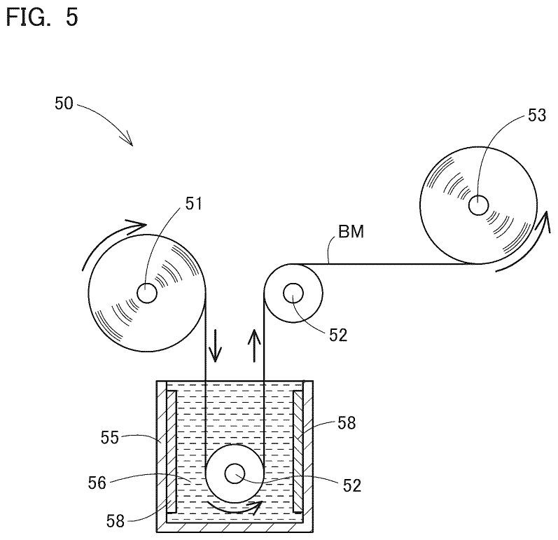

FIG. 5 is a schematic diagram illustrating the configuration of a surface treatment device 50 used in the process P2. The surface treatment device 50 includes, as a transfer portion of the base material BM, a delivery roller 51 with the base material BM prior to the surface treatment wound thereon, a plurality of guide rollers 52 configured to guide the transfer of the base material BM, and a winding roller 53 configured to wind up the base material BM after the surface treatment. The surface treatment device 50 further includes, as an electrolytic deposition portion, an electrolytic bath 55 filled with an electrolytic solution 56 and electrode plates 58 placed in the electrolytic bath 55. The surface treatment device 50 also includes a power supply portion configured to supply electricity to the electrode plates 58 and the base material BM, although not being specifically illustrated.

The base material BM is pulled out from the delivery roller 51, is guided by the plurality of guide rollers 52 and is transferred to the winding roller 53. One of the guide rollers 52 is placed inside of the electrolytic bath 55. The base material BM is accordingly transferred into the electrolytic bath 55, is soaked in the electrolytic solution 56 in the electrolytic bath 55, is turned back in the electrolytic bath 55, and is transferred to outside of the electrolytic bath 55. While the base material BM passes through the electrolytic solution 56 in the electrolytic bath 55, the surface of the base material BM is subjected to surface treatment by electrolytic deposition described below.

The electrolytic solution 56 in the electrolytic bath 55 is a solution that enables the same type of metal atom as the metal constituting the base material BM to be dissolved. For example, sulfuric acid (H₂SO₄) may be used as the electrolytic solution 56. The electrolytic solution 56 may have a concentration of approximately 0.5 to 2.0 M (molar concentration mol/L).

The electrode plates 58 placed in the electrolytic bath 55 include the same type of metal atom as the metal constituting the base material BM. According to the embodiment, the electrode plates 58 are made of crude copper. The electrode plates 58 are placed to face a surface of the base material BM transferred in the electrolytic bath 55. It is preferable that the electrode plates 58 are placed substantially parallel to the surface of the base material BM. The distance between the electrode plate 58 and the base material BM may be, for example, approximately 2.0 to 6.0 cm.

During transfer of the base material BM, the power supply portion applies a voltage and applies electric current to the electrode plate 58 as the positive electrode and the base material BM as the negative electrode. The applied voltage may be, for example, 0.5 to 2.0 V. The electric current may be, for example, approximately 80.0 to 200.0 mA, and the current density may be approximately 15.0 to 30.0 mA/cm². The environment temperature may be room temperature and may be a temperature in a range of 10 to 30° C. Processing conditions, such as the type and the concentration of the electrolytic solution 56, the applied voltage, and the transfer rate of the base material BM, in the surface treatment device 50 are appropriately regulated such as to form the convexes 24 of the dimensions described above.

In the process of electrolytic deposition in the surface treatment device 50, Cu of the electrode plate 58 is oxidized to be dissolved in the form of Cu ion into the electrolytic solution 56, is moved toward the base material BM, and is reduced to deposit on the surface of the base material BM. The convexes 24 are thus sequentially formed by the depositing Cu particles on the surface of the base material BM. The convexes 24 are formed to be distributed over the entire surface of the base material BM.

According to a modification, the surface treatment device 50 may have a configuration provided with a plurality of guide rollers 52 placed in one electrolytic bath 55 to repeat soaking of the base material BM multiple times into the electrolytic solution 56 in one electrolytic bath 55. According to another modification, the surface treatment device 50 may have a multistage configuration provided with a plurality of electrolytic baths 55 with the guide rollers 52 placed in the respective electrolytic baths 55 to transfer the base material BM and repeat soaking of the base material BM into the electrolytic solution 56 in the respective electrolytic baths 55. In this modification, the processing conditions, such as the type and the concentration of the electrolytic solution 56, the applied voltage, and the transfer rate of the base material BM, in each of the electrolytic baths 55 are appropriately regulated such as to form the convexes 24 of the dimensions described above.

It is preferable that the surface treatment of the process P2 is performed for both the surfaces of the base material BM. In the surface treatment device 50, the winding roller 53 with the base material BM having one surface-treated surface wound up thereon is replaced as the delivery roller 51, and the base material BM is again transferred in the electrolytic bath 55. This causes the other surface of the base material BM to be subjected to the surface treatment and thereby completes the metal substrate 21 with the fine concavo-convex structure 23 formed on both the surfaces thereof.

Referring to FIG. 4, a subsequent process P3 is manufacturing the second electrode 30 serving as the positive electrode. A process P4 is assembling the first electrode 20 and the second electrode 30 to the container 11 filled with the electrolytic solution 12 as shown in FIG. 1. The metal substrate 21 forming the first electrode 20 is placed in the container 11 in the state that the convexes 24 of the concavo-convex structure 23 are directly soaked in the electrolytic solution 12. This series of processes completes the secondary battery 10.

As described above, the manufacturing process of the secondary battery 10 according to the embodiment performs surface treatment by electrolytic deposition and thereby enables the metal substrate 21 with the concavo-convex structure 23 formed on both the surfaces thereof to be efficiently manufactured. Furthermore, there is no need to form an active material layer on the metal substrate 21. This reduces the number of processes and reduces the manufacturing cost of the secondary battery 10.

As described above, the electrode 20 prepared by the processes P1 and P2 is free from a problem, such as damage or drop-off of an active material layer even in the case where the electrode 20 is rolled up and transferred. This facilitates handling of the electrode 20. This accordingly enhances the mass productivity of the electrode 20 and facilitates manufacture of the secondary battery 10 using the electrode 20.

### EXAMPLES

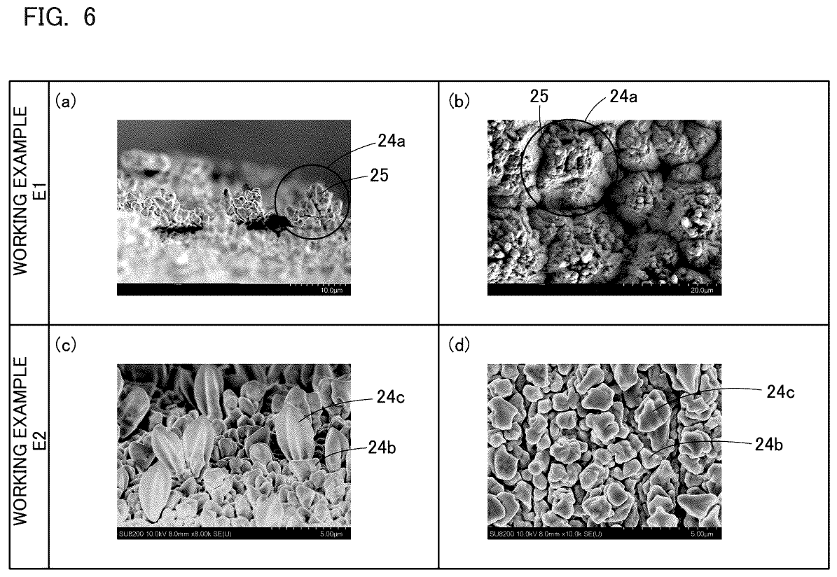

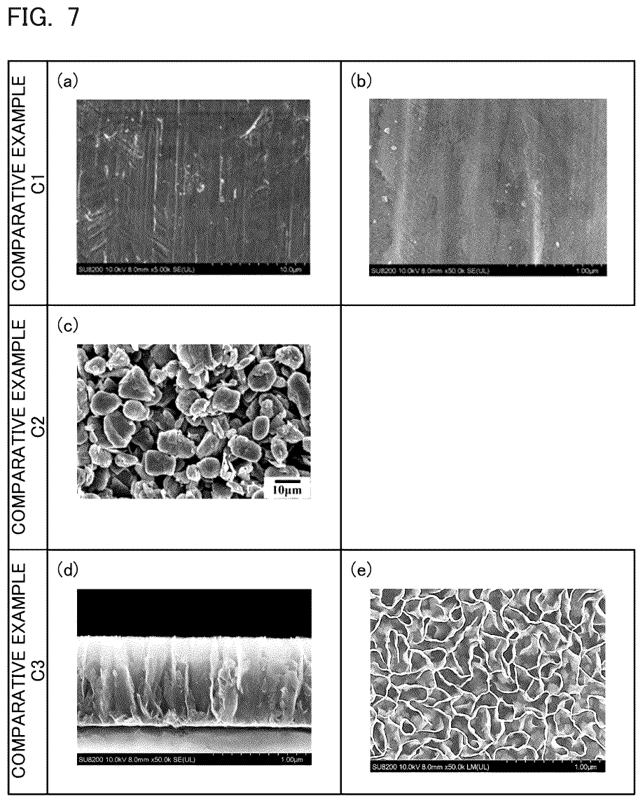

The following describes working examples E1 and E2 of the electrode 20 according to the embodiment and comparative examples C1, C2 and C3 with referring to FIG. 6 and FIG. 7.

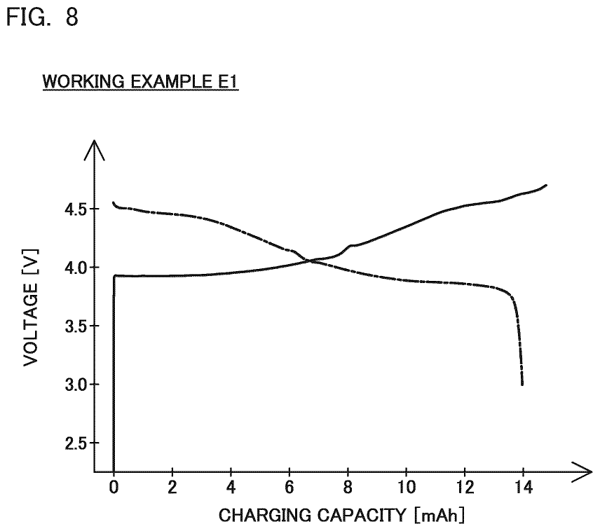

In FIG. 8, cells (a) and (b) respectively show photographed images of the concavo-convex structure 23 of the metal substrate 21 of the working example E1. In FIG. 8, cells (c) and (d) respectively show photographed images of the surface of the concavo-convex structure 23 of the working example E2. In FIG. 8, cells (a) and (c) show images of the convexes 24 taken from a direction perpendicular to the thickness direction of the metal substrate 21 by a scanning electron microscope. In FIG. 8, cells (b) and (d) show images of the surface of the metal substrate 21 taken in the thickness direction of the metal substrate 21 by a scanning electron microscope. The images of cells (b) and (d) in FIG. 8 correspond to images of projection ranges obtained by projecting the convexes 24 in the thickness direction of the metal substrate 21.

The metal substrates 21 of the working examples E1 and E2 were produced by using a copper foil as the base material and performing surface treatment by electrolytic deposition described above. The electrolytic deposition of the working example E2 used a 1.5 M H₂SO₄ solution as the electrolytic solution, applied a DC voltage of 1.0 V to the base material in the electrolytic solution, and applied electric current of 128 mA. The distance between the base material and the electrode was 3.5 cm. This electrolytic deposition was performed in the room temperature environment. The transfer rate of the base material in the electrolytic solution was appropriately regulated according to the target dimensions of the convexes 24, based on results of preliminary experiments.

As shown cells (a) and (b) in FIG. 8, the concavo-convex structure 23 of the working example E1 had a plurality of protrusions 24a formed by densely gathering the metal particles 25 in a cluster, as the convexes 24. In the working example E1, the plurality of protrusions 24a were adjacent to each other and were distributed over the entire surface of the metal substrate 21. The maximum widths Wmax of the respective protrusions 24a were in a range of approximately 1.0 to 30.0 μm. The heights Hp of the respective protrusions 24a were in a range of approximately 1.0 to 15.0 μm. The particle diameters Rp of the metal particles 25 configuring the protrusions 24a were in a range of approximately 0.5 to 5.0 μm.

As shown in cells (c) and (d) in FIG. 8, the concavo-convex structure 23 of the working example E2 had the first granules 24b and the second granules 24c, as the convexes 24. In the working example E2, the second granules 24c were mixed among the first granules 24b distributed over the entire surface of the metal substrate 21.

The particle diameters Rq of the first granules 24b were in a range of approximately 0.5 to 5.0 μm. The heights Hq of the first granules 24b were in a range of approximately 0.1 to 5.0 μm.

The particle diameters Rr of the second granules 24c were in a range of approximately 0.5 to 8.0 μm. The heights Hr of the second granules 24c were in a range of approximately 1.0 to 15.0 μm. There were many second granules 24c having vertically long elliptical shapes.

In both the working examples E1 and E2, the area of the projection range obtained by projecting the convexes 24 in the thickness direction of the metal substrate 21 was in a range of greater than 0.01 μm² and not greater than 10000 μm². The density of the projection range of the convexes 24 obtained by projecting the metal substrate 21 in the thickness direction was in a range of not less than 1 piece/mm² and less than 10⁸ pieces/mm².

In FIG. 7, cells (a) and (b) show photographed images of a surface of a metal substrate configuring an electrode of the comparative example C1. The cell (a) in FIG. 7 shows a photographed image taken from a direction facing the surface of the metal substrate of the comparative example C1 by a scanning electron microscope. The cell (b) in FIG. 7 shows an image taken at a higher magnification than that of the photographed image of the cell (a) in FIG. 7.

The electrode of the comparative example C1 was formed by a metal substrate that did not have an active material layer and that served as a current collector like the working examples E1 and E2. The metal substrate of the comparative example C1 had a similar configuration to those of the metal substrates of the working examples E1 and E2, except that the metal substrate of the comparative example C1 was not subjected to surface treatment by electrolytic deposition, unlike the working example E1 and E2. As shown in the images of cells (a) and (b) in FIG. 7, the metal substrate of the comparative example C1 had a substantially flat plane without irregularities.

In FIG. 7, cell (c) shows a photographed image of an electrode of the comparative example C2. The cell (c) in FIG. 7 shows an image taken from a direction facing a surface of an active material layer of the comparative example C2 by a scanning electron microscope. The electrode of the comparative example C2 had a configuration provided with an active material layer of graphite on the surface of a metal substrate having a flat plane similar to that of the comparative example C1. The cell (c) in FIG. 7 shows particles of graphite forming the active material layer.

In FIG. 7, cells (d) and FIG. 7(e) show photographed images of an electrode of the comparative example C3. The cell (d) in FIG. 7 shows an image of a surface layer of the electrode taken from a direction perpendicular to a thickness direction of the electrode of the comparative example C1 by a scanning electron microscope. The cell (e) in FIG. 7 shows an image taken from a direction facing the surface of the electrode of the comparative example C1 by a scanning electron microscope.

The electrode of the comparative example C3 had a configuration provided with an active material layer of carbon nanowalls on the surface of a metal substrate having a flat plane similar to that of the comparative example C1. White folded portions in the image of the cell (d) in FIG. 7 and white net-like streak portions in the image of the cell (e) in FIG. 7 are carbon nanowalls. The carbon nanowalls were formed in a random netlike shape over the entire surface of the metal substrate to have a substantially uniform height of approximately 1.0 μm by a CVD technique.

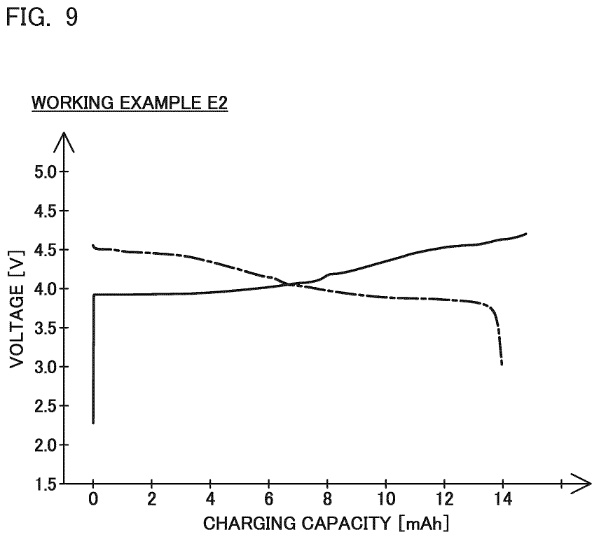

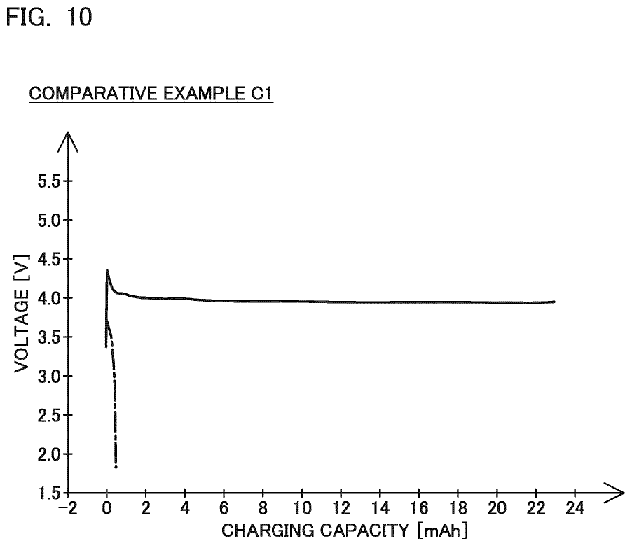

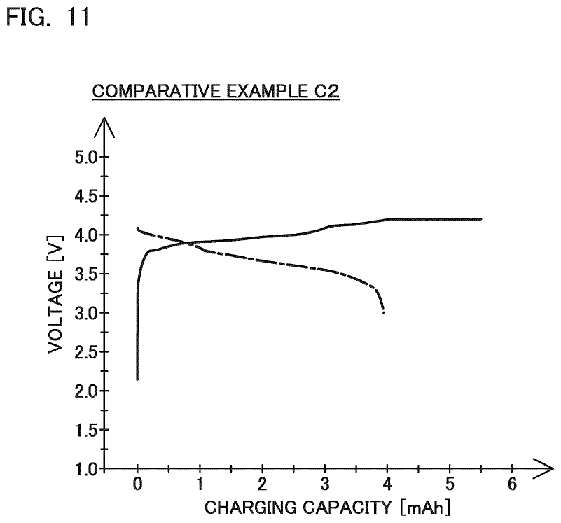

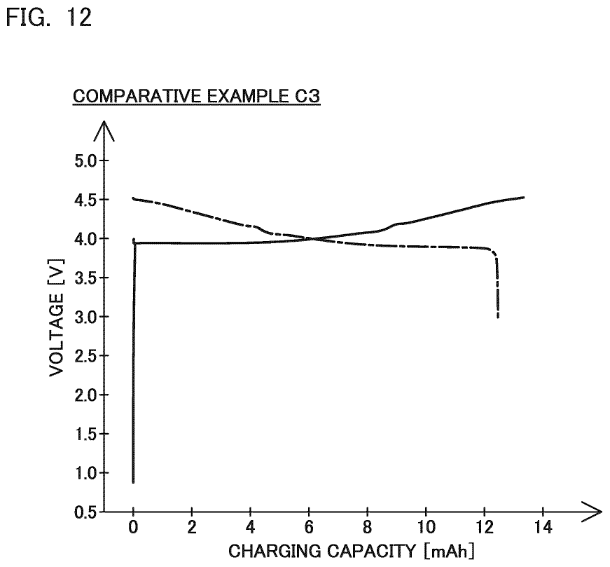

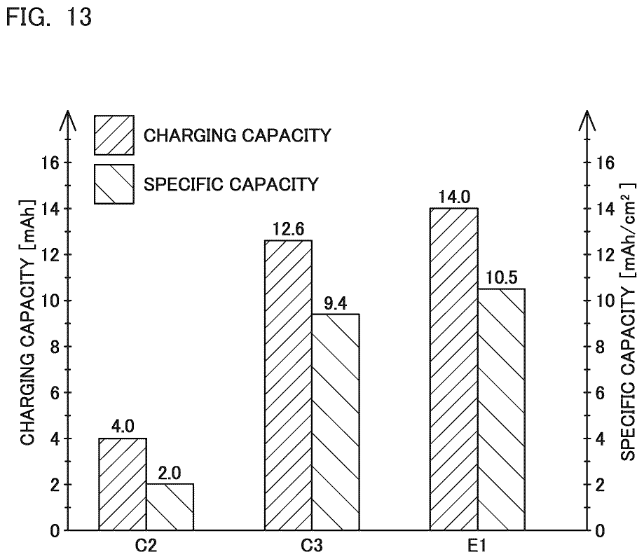

FIGS. 8 to 13 are explanatory diagrams showing results of an evaluation test of the battery performance of secondary batteries respectively using the electrodes of the working example E1, the working example E2, the comparative example C1, the comparative example C2 and the comparative example C3 described above as the negative electrode. FIG. 8 and FIG. 9 respectively show graphs obtained with regard to the secondary batteries using the electrode of the working example E1 and the electrode of the working example E2. FIG. 10, FIG. 11 and FIG. 12 respectively show graphs obtained with regard to the secondary batteries using the electrode of the comparative example C1, the electrode of the comparative example C2 and the electrode of the comparative example C3. In FIG. 8 to FIG. 12, a relationship between the voltage and the charging capacity of the secondary battery is shown as a solid-line graph in the charging process and is shown as a dash-dotted line graph in the discharging process. FIG. 13 shows charging capacities and specific capacities of the secondary batteries of the working example E1 and of the comparative examples C2 and C3 in the form of bar graphs. In this evaluation test, both the charge current and the discharge current were 0.5 mA.

The secondary batteries using the working examples E1 and E2 and the comparative examples C1, C2 and C3 were all lithium ion secondary batteries and were manufactured to have the configuration shown in Table 1 given below.

TABLE 1

| | | |
|---|---|---|
| Positive | Positive Electrode Current Collector | Al |
| Electrode | Positive Electrode Active Material | LiCoO₂ |
| | Conductive Assistant | Acetylene Black |
| | Binding Agent | PVDF |
| | Weight Ratio | 100:5:3 |
| | (Positive Electrode Active Material: | |
| | Conductive Assistant:Binding Agent) | |
| | Formation Range of Positive | Range of 1.3 cm |
| | Electrode Active Material Layer | in Diameter |
| Negative | Formation Range of Negative | Range of 1.6 cm |
| Electrode | Electrode Active Material Layer | in Diameter |

| | |
|---|---|
| Electrolytic Solution | 1 M LPF [symbol] |

[symbol]

indicates data missing or illegible when filed

As shown in FIG. 10, the secondary battery using the electrode of the comparative example C1 configured by only the metal substrate having the flat plane as the negative electrode was neither charged nor discharged. This result indicates that the metal substrate without the concavo-convex structure on the outer surface does not work as the electrode of the secondary battery.

As shown in FIG. 11 and FIG. 13, the secondary battery using the comparative example C2 having the active material layer of graphite had the charging capacity of 4.0 [mAh] and the specific capacity of 2.0 [mAh/cm²]. As shown in FIG. 12 and FIG. 13, the secondary battery using the comparative example C3 having the active material layer of carbon nanowalls of the uniform thickness had the charging capacity of 12.6 [mAh] and the specific capacity of 9.4 [mAh/cm²].

The results of the comparative examples C1, C2 and C3 show that providing the active material layer on the flat metal substrates achieves the functions as the electrode of the secondary battery. These results also show that applying carbon nanowalls for the active material layer of the negative electrode more significantly improves the battery performance of the secondary battery, compared with applying graphite for the active material layer.

As shown in FIG. 8 and FIG. 9, on the other hand, both the secondary batteries using the working examples E1 and E2 had the charging capacities of approximately 14.0 [mAh]. As shown in FIG. 13, the secondary battery using the working example E1 had the specific capacity of 10.5 [mAh/cm²]. The secondary battery using the working example E2 had an equivalent level of specific capacity, although not being specifically illustrated in FIG. 13.

As described above, both the secondary batteries using the working examples E1 and E2 had significantly improved battery performances, compared with the secondary batteries using the comparative examples C2 and C3 having the active material layers. This result is due to that the convexes 24 of the concavo-convex structure 23 formed on the metal substrate 21 in each of the working examples E1 and E2 accelerate deposition of Li, compared with the active material layers. This result is thought to defy the common wisdom that an active material layer is required for the electrode of the secondary battery. Furthermore, improvement of the battery performance by the absence of the active material layer is a novel discovery that is not at all easily achievable from the common general technical knowledge.

As described above, the electrode for the secondary battery of the present disclosure and the secondary battery using this electrode significantly improve the battery performance of the secondary battery. Furthermore, the electrode for the secondary battery of the present disclosure has a simple configuration without an active material layer. This facilitates manufacture of the electrode for the secondary battery and manufacture of the secondary battery.

### 2. Other Embodiments

The present disclosure is not limited the configurations of the embodiment and the examples described above but may be implemented, for example, by other embodiments described below. The configurations described below as other embodiments should be interpreted as only examples of the aspects of implementing the present disclosure, like the embodiment described above, the configurations described as modifications in the description of the embodiment, and the examples.

### 2-1. Another Embodiment 1

The metal substrate 21 of the above embodiment may be formed of a metal other than Cu. The metal substrate 21 may be formed of, for example, a Cu alloy, Al or an Al alloy.

### 2-2. Another Embodiment 2

The secondary battery using the electrode 20 of the above embodiment may be configured to involve a metal ion other than lithium ion in charging and discharging. The secondary battery using the electrode 20 of the above embodiment may be configured to involve, for example, sodium (Na) ion, potassium (K) ion, magnesium (Mg) ion in charging and discharging.

### 2-3. Another Embodiment 3

The convexes 24 of the concavo-convex structure 23 may have a structure different from the protrusions 24a and the granules 24b and 24c. The convexes 24 of the concavo-convex structure 23 may have, for example, an approximately hemispherical shape or an approximately conical shape.

### 2-4. Another Embodiment 4

In the manufacturing method of the secondary battery 10 described in the above embodiment, the process P2 may form the concavo-convex structure 23 on the base material BM of the metal substrate 21 by a technique other than electrolytic deposition. The concavo-convex structure 23 of the metal substrate 21 may be formed, for example, by surface treatment of the CVD technique or by oxidation treatment of a metal substrate.

### 3. Examples of Aspects

The present disclosure may be implemented by aspects described below.

### First Aspect

According to a first aspect, a secondary battery is provided as follow. The secondary battery of the first aspect comprises a container filled with an electrolytic solution; a separator having electrical insulation property and ion conductivity and configured to divide an internal space of the container into a first electrode chamber and a second electrode chamber; a first electrode configured by a metal substrate and placed in the first electrode chamber; and a second electrode placed in the second electrode chamber and including a metal atom which is ionized and moved to the first electrode. The metal substrate has a fine concavo-convex structure, which is formed on an outer surface, including a plurality of convexes that are made of metal particles having a maximum width of not less than 0.5 μm and not greater than 30.0 μm. The secondary battery is configured so that the metal atom deposits on surface of the convexes in a process of charging.

The secondary battery of the first aspect enhances the charging capacity and improves the battery performance by the novel and simple configuration that is provided with the concavo-convex structure including the convexes made of the metal particles on the metal substrate and that is not provided with an active material layer in the first electrode. The secondary battery of the first aspect does not require to provide an active material layer in the first electrode. This configuration simplifies the manufacturing process of the secondary battery and reduces the manufacturing cost of the secondary battery.

### Second Aspect

In the secondary battery described in the above first aspect, the convex may include a protrusion formed by densely gathering a plurality of metal particles having a particle diameter of not less than 0.5 μm and not greater than 5.0 μm.

In the secondary battery of this second aspect, the convex is readily configured by the protrusion formed by densely gathering fine metal particles in a cluster. This configuration further improves the battery performance.

### Third Aspect

In the secondary battery described in the above second aspect, the protrusion may have a height of not less than 1.0 μm and not greater than 15.0 μm.

In the secondary battery of the third aspect, the protrusion further accelerates deposition of the metal atom involved in a battery reaction in the first electrode. This configuration further improves the battery performance.

### Fourth Aspect

In the secondary battery described in any one of the above first aspect, second aspect, and third aspect, the convex may include a vertically long granule having a particle diameter of not less than 0.5 μm and not greater than 5.0 μm and having a height greater than the particle diameter.

The secondary battery of the fourth aspect has the granules configuring the convexes. This configuration further improves the battery performance.

### Fifth Aspect

In the secondary battery described in any one of the above first aspect, second aspect, third aspect, and fourth aspect, an area of a projection range obtained by projecting the convexes in a thickness direction of the metal substrate may be greater than 0.01 μm² and not greater than 10000 μm², and a density of a projection range of the convexes obtained by projecting the metal substrate in the thickness direction may be not less than 1 piece/mm² and less than 10⁸ pieces/mm².

In the secondary battery of this fifth aspect, a large number of convexes are allowed to be present on the surface of the electrode. Accordingly, this configuration further improves the battery performance.

### Sixth Aspect

In the secondary battery described in any one of the above first aspect, second aspect, third aspect, fourth aspect, and fifth aspect, the metal substrate may be formed of copper or a copper alloy.

The secondary battery of this sixth aspect enables the concavo-convex structure to be readily formed on the outer surface of the metal substrate. This configuration thus readily improves the battery performance.

### Seventh Aspect

According to a seventh aspect, there is provided a metal substrate used as an electrode of a secondary battery. The metal substrate of the seventh aspect has a fine concavo-convex structure including a plurality of convexes, which are made of metal particles having a maximum width of not less than 0.5 μm and not greater than 30.0 μm. The metal substrate is placed in a container of the secondary battery, which is filled with an electrolytic solution, in such a state that the convexes are directly soaked in the electrolytic solution.

The metal substrate of this seventh aspect is usable as an electrode for a secondary battery, which is not provided with an active material layer on an outer surface thereof. This provides the secondary battery having high battery performance.

### Eighth Aspect

According to an eighth aspect, there is provided a manufacturing method of a secondary battery. The manufacturing method of the eighth aspect comprises forming a fine concavo-convex structure on a surface of a metal substrate, the fine concavo-convex structure includes a plurality of convexes, which are made of metal particles having a maximum width of not less than 0.5 μm and not greater than 30.0 μm; and assembling the metal substrate, as an electrode of the secondary battery in a container filled with an electrolytic solution, in a state that the convexes is directly soaked in the electrolytic solution.

The manufacturing method of this eighth embodiment enables a secondary battery having high battery performance to be manufactured by a simple manufacturing process that does not require a process of providing an active material layer on an outer surface of the metal substrate.

### Ninth Aspect

In the manufacturing method described in the above eighth aspect, the process of forming the concavo-convex structure may comprise forming the convexes by electrolytic deposition that causes metal particles to deposit on an outer surface of the metal substrate.

The manufacturing method of this ninth aspect enables the concavo-convex structure that contributes charging and discharging of the secondary battery to be readily formed on respective surfaces of the metal substrate. This configuration thus enables the secondary battery having high battery performance to be more readily manufactured.

### Tenth Aspect

According to a tenth aspect, there is provided a manufacturing method of an electrode for a secondary battery. The manufacturing method of the tenth aspect comprises providing a base material of a metal substrate that configures the electrode; and soaking the base material in an electrolytic solution in an electrolytic bath, such as to form a fine concavo-convex structure on the base material by electrolytic deposition, the fine concavo-convex structure includes an arrangement of a plurality of convexes, which are made of metal particles having a maximum width of not less than 0.5 μm and not greater than 30.0 μm. The metal substrate is placed in a container of the secondary battery in such a state that the convexes are directly soaked in the electrolytic solution.

The manufacturing method of this tenth aspect enables the concavo-convex structure that contributes charging and discharging of the secondary battery to be readily formed on an outer surface of the metal substrate.

### REFERENCE SIGNS LIST

10 . . . secondary battery, 11 . . . container, 12 . . . electrolytic solution, 15 . . . separator, 16 . . . first electrode chamber, 17 . . . second electrode chamber, 20 . . . electrode (first electrode), 21 . . . metal substrate, 21a . . . first surface, 21b . . . second surface, 23 . . . concavo-convex structure, 24 . . . convex, 24a . . . protrusion, 24b . . . first granule, 24c . . . second granule, 25 . . . metal particle, 30 . . . second electrode, 31 . . . positive electrode current collector, 32 . . . positive electrode active material layer, 50 . . . surface treatment device, 51 . . . delivery roller, 52 . . . guide roller, 53 . . . winding roller, 55 . . . electrolytic bath, 56 . . . electrolytic solution, 58 . . . electrode plate, BM . . . base material

1. A secondary battery, comprising:
a container filled with an electrolytic solution;
a separator having electrical insulation property and ion conductivity and configured to divide an internal space of the container into a first electrode chamber and a second electrode chamber;
a first electrode configured by a metal substrate and placed in the first electrode chamber; and
a second electrode placed in the second electrode chamber and including a metal atom which is ionized and moved to the first electrode, wherein
the metal substrate has a fine concavo-convex structure, which is formed on an outer surface, including a plurality of convexes that are made of metal particles having a maximum width of not less than 0.5 □m and not greater than 30.0 □m, and
the metal atoms deposit on surface of the convexes in a process of charging.

2. The secondary battery according to claim 1,
wherein the convex includes a protrusion formed by densely gathering a plurality of metal particles having a particle diameter of not less than 0.5 μm and not greater than 5.0 μm.

3. The secondary battery according to claim 2,
wherein the protrusion has a height of not less than 1.0 μm and not greater than 15.0 μm.

4. The secondary battery according to claim 1,
wherein the convex includes a vertically long granule having a particle diameter of not less than 0.5 μm and not greater than 5.0 μm and having a height greater than the particle diameter.

5. The secondary battery according to claim 1,
wherein an area of a projection range obtained by projecting the convexes in a thickness direction of the metal substrate is greater than 0.01 μm² and not greater than 10000 μm², and
a density of a projection range of the convexes obtained by projecting the metal substrate in the thickness direction is not less than 1 piece/mm² and less than 10⁸ pieces/mm².

6. The secondary battery according to claim 1,
wherein the metal substrate is formed of copper or a copper alloy.

7. (canceled)

8. A manufacturing method of a secondary battery, comprising:
forming a fine concavo-convex structure on a surface of a metal substrate, the fine concavo-convex structure includes a plurality of convexes, which are made of metal particles having a maximum width of not less than 0.5 μm and not greater than 30.0 μm, on a surface of a metal substrate; and
assembling the metal substrate as an electrode of the secondary battery in a container filled with an electrolytic solution in a state that the convexes is directly soaked in the electrolytic solution.

9. The manufacturing method according to claim 8,
forming the convexes by electrolytic deposition that causes metal particles to deposit on an outer surface of the metal substrate in the process of forming the concavo-convex structure.

10. A manufacturing method of an electrode for a secondary battery, comprising:
providing a base material of a metal substrate that configures the electrode; and
soaking the base material in an electrolytic solution in an electrolytic bath, such as to form a fine concavo-convex structure on the base material by electrolytic deposition, the a fine concavo-convex structure includes an arrangement of a plurality of convexes, which are made of metal particles having a maximum width of not less than 0.5 μm and not greater than 30.0 μm, wherein
the metal substrate is placed in a container of the secondary battery in such a state that the convexes are directly soaked in the electrolytic solution.

11. The secondary batter according to claim 2,
wherein the convex includes a vertically long granule having a particle diameter of not less than 0.5 μm and not greater than 5.0 μm and having a height greater than the particle diameter.

12. The secondary battery according to claim 2,
wherein an area of a projection range obtained by projecting the convexes in a thickness direction of the metal substrate is greater than 0.01 μm² and not greater than 10000 μm², and
a density of a projection range of the convexes obtained by projecting the metal substrate in the thickness direction is not less than 1 piece/mm² and less than 10⁸ pieces/mm².

13. The secondary battery according to claim 4,
wherein an area of a projection range obtained by projecting the convexes in a thickness direction of the metal substrate is greater than 0.01 μm² and not greater than 10000 μm², and
a density of a projection range of the convexes obtained by projecting the metal substrate in the thickness direction is not less than 1 piece/mm² and less than 10⁸ pieces/mm².

14. The secondary battery according to claim 11,
wherein an area of a projection range obtained by projecting the convexes in a thickness direction of the metal substrate is greater than 0.01 μm² and not greater than 10000 μm², and
a density of a projection range of the convexes obtained by projecting the metal substrate in the thickness direction is not less than 1 piece/mm² and less than 10⁸ pieces/mm².

15. The secondary battery according to claim 2,
wherein the metal substrate is formed of copper or a copper alloy.

16. The secondary battery according to claim 4,
wherein the metal substrate is formed of copper or a copper alloy.

17. The secondary battery according to claim 5,
wherein the metal substrate is formed of copper or a copper alloy.

18. The secondary battery according to claim 11,
wherein the metal substrate is formed of copper or a copper alloy.

19. The secondary battery according to claim 12,
wherein the metal substrate is formed of copper or a copper alloy.

20. The secondary battery according to claim 13,
wherein the metal substrate is formed of copper or a copper alloy.

21. The secondary battery according to claim 14,
wherein the metal substrate is formed of copper or a copper alloy.
